(19) United States
(12) Patent Application Publication
(10) Pub. No.: US 2026/0196636 A1
(43) Pub. Date: Jul. 9, 2026

(54) BATTERY CADDIE

(71) Applicant: Greenworks (Jiangsu) Co., Ltd, Changzhou (CN)

(72) Inventors: Zhenyu Huang, Changzhou (CN); Chuntao Lu, Changzhou (CN); Nicholas Suchoza, Mooresville, NC (US); Troy Efird, Mooresville, NC (US); An Yan, Changzhou (CN); Yanqiang Zhu, Changzhou (CN)

(21) Appl. No.: 19/555,934

(22) Filed: Mar. 4, 2026

Related U.S. Application Data
(63) Continuation of application No. PCT/CN2023/117497, filed on Sep. 7, 2023.

(51) Int. Cl. H01M 50/264; H01M 10/613; H01M 10/6563; H01M 50/256; H01M 50/271

(52) U.S. Cl. CPC H01M 50/264; H01M 10/613; H01M 10/6563; H01M 50/256; H01M 50/271; H01M 2220/20

(57) ABSTRACT

A battery caddie includes: a body having one or more receptacles for receiving one or more batteries; a cover movable between an open position which exposes the one or more receptacles, and a closed position; a charging connector; and an electrical connection between the charging connector and the one or more receptacles.

### CROSS REFERENCE TO RELATED APPLICATIONS

The present application is a Continuation Application of PCT Application No. PCT/CN2023/117497 filed on Sep. 7, 2023, the contents of which are incorporated herein by reference in their entirety.

### BACKGROUND OF THE INVENTION

This invention relates generally to battery-powered equipment and more particularly to battery charging equipment.

Battery-powered vehicles and equipment are in widespread use. For home use, the batteries are typically charged using individual chargers or power supply equipment for each type and brand of vehicle or equipment.

For commercial use, for example use by a landscaping business, it often becomes necessary to acquire numerous batteries for the various pieces of equipment. These batteries must be organized and charged in large numbers, and then distributed to users.

Accordingly, there is a need for a means of bulk charging and distribution of batteries.

### BRIEF SUMMARY OF THE INVENTION

This need is addressed by a charging system having one or more caddies each capable of charging multiple batteries simultaneously.

According to one aspect of the technology described herein, a battery caddie includes: a body having one or more receptacles for receiving one or more batteries; a cover movable between an open position which exposes the one or more receptacles, and a closed position; a charging connector; and an electrical connection between the charging connector and the one or more receptacles.

### BRIEF DESCRIPTION OF THE DRAWINGS

The invention may be best understood by reference to the following description taken in conjunction with the accompanying drawing figures in which:

FIG. 1 is a perspective view of a battery charging system;

FIG. 2 is a simplified functional diagram of the battery charging system of FIG. 1;

FIG. 3 is a front view of a switch of the battery charging system of FIG. 1;

FIG. 4 is a perspective view of the exterior of a battery caddie;

FIG. 5 is a view of the battery caddie of FIG. 4 with a cover removed showing the internal components;

FIG. 6 is a bottom perspective view of the battery caddie of FIG. 4;

FIG. 7 is a simplified functional diagram of an alternative battery charging system; and

FIG. 8 is a simplified functional diagram of another alternative battery charging system.

### DETAILED DESCRIPTION OF THE INVENTION

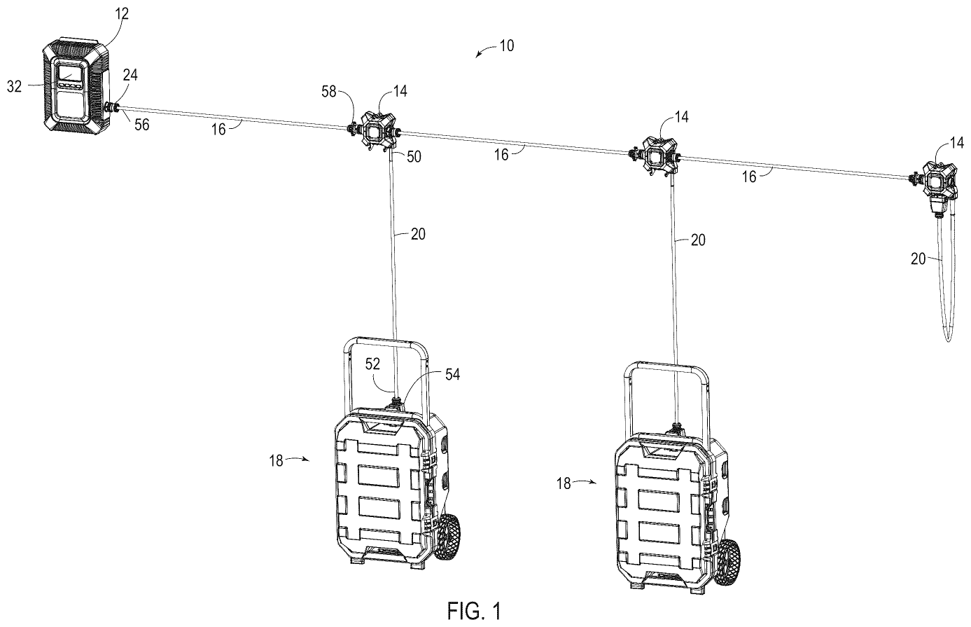

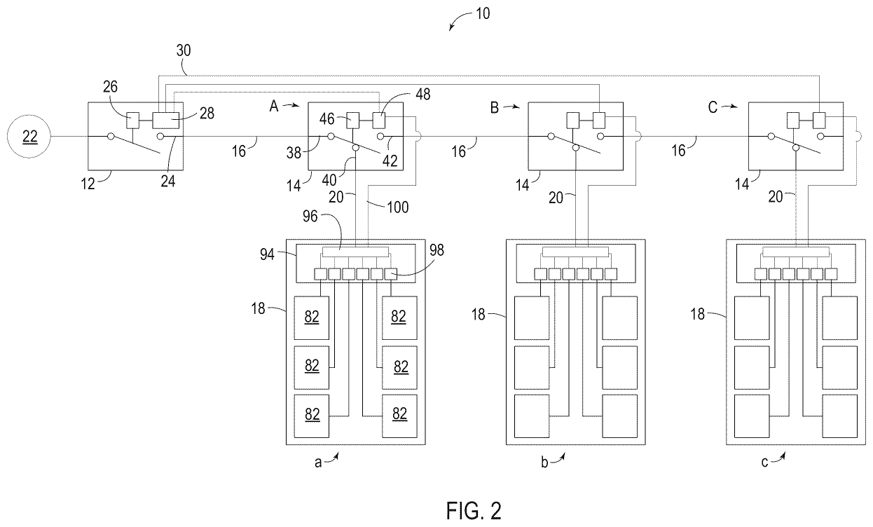

Referring to the drawings, FIGS. 1 and 2 show a representative embodiment of a charging system 10 including a charger 12 connected to an array of switches 14 by a series of transfer cables 16. Each of the switches 14 is connected to a battery caddie 18 by a charging cable 20. Each battery caddie 18 includes internal receptacles which physically and electrically connect to a plurality of batteries. The charger 12 is configured to be connected to mains power and to selectively send power to the caddies to charge the batteries as required.

The charger 12 is operable to receive line voltage, e.g., 120 V to 240 V AC and to supply DC charging current at one or more predetermined voltages. It may accomplish this function by the use of one or more rectifiers, DC-DC converters, and associated components.

The charger 12 has an input connection 21 that may be coupled to a suitable power source of line voltage electric power (shown schematically at 22 in FIG. 2). In one example, the charger 12 may be hardwired to a building electrical circuit. In another example, the charger 12 may have a receptacle permitting it to be coupled to an electric vehicle supply equipment (“EVSE”) device (not shown) which is operable to supply charging current. For example, the EVSE device may follow the SAE J1772 standard.

The charger 12 includes an output connection 24 from which charging current is supplied. The charger 12 includes means for selectively connecting or disconnecting the input connection 21 to the output connection 24. In the illustrated example, this is shown as a relay 26, but other devices having the same functional capability could be substituted.

A charger controller 28 is provided for the charger 12. The charger controller 28 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC). The charger controller 28 is operably connected to the relay 26 such that it can cause the relay 26 to open or close. It also has a data connection for receiving signals and/or data from the switches 14. These connections are shown as data lines 30 in the example. Alternatively, signals and/or data could be exchanged between the switches 14 and the charger controller 28 using a wireless connection, such as Bluetooth or Wi-Fi or RF or LoRa protocol. The charger controller 28 may be coupled to user controls 32 (FIG. 1) such as a touch screen, keypad, lights, or switches.

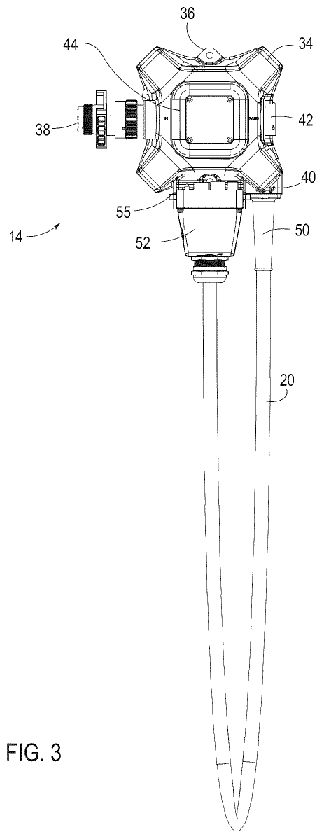

FIG. 3 illustrates one of the switches 14. The switch 14 has a housing 34 which encloses and protects the functional components of the switch 14. It may be provided with provisions for mounting the switch 14 to a wall or other structure, such as the illustrated bracket 36. The switch 14 includes an input connection 38, an output connection 40, and a pass-through connection 42. The housing 34 includes a display 44 operable to display information or indicia communicating the status of the switch 14. In the illustrated example, the display 44 comprises a light which may be selectively illuminated in multiple colors depending upon switch status. For example, different LED colors may indicate (1) it is charging the caddie connected to it, or (2) has an error that needs user intervention, or (3) has an error that is it resolving on its own, or (4) if waiting for an input charge (from a switch that is between it and the charger), or (5) passing power to the next switch.

The switch 14 includes means for receiving charging current from the input connection 38 and selectively directing charging current either to the output connection 40 or to the pass-through connection 42 as needed, depending on the system charging logic described further below. In the illustrated example, this is shown as a relay 46 (FIG. 2), but other devices having the same functional capability could be substituted. Stated another way, each switch 14 has a first position which directs electrical current from its input connection to its output connection, and a second position which directs electrical current from its input connection to its pass-through connection.

A switch controller 48 is provided for the switch 14. The switch controller 48 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC). The switch controller 48 is operably connected to the switch 14 such that it can cause the relay 46 to change position. It also has a connection 30 for receiving signals and/or data from the charger 12, as described above. The switch controller 48 may be coupled to the display 44 described above.

A charging cable 20 has a first end 50 coupled to the output connection 40 of the switch 14 and a second end 52 terminating in a connector configured to mate with a charging connector 54 of the battery caddie 18 described elsewhere herein. The charging cable 20 contains electrical conductors suitable for conducting charging current to a battery caddie 18 and may optionally include one or more electrical conductors for transmitting data and/or commands between the battery caddie 18 and the switch 14. In the illustrated example, the second end 52 of the charging cable 20 is configured so that it can be stored when not in use by hanging it from a hook 55 that forms part of the housing 34 of the switch 14.

Each transfer cable 16 has a first end 56 terminating in a connector configured to mate with the output connection 24 of the charger 12 or the pass-through connection 42 of an upstream switch 14. Each transfer cable has a second end 58 terminating in a connector configured to mate with the input connector of a downstream switch 14. The transfer cable 16 contains electrical conductors suitable for conducting charging current and may optionally include one or more electrical conductors for transmitting signals and/or data (i.e., the data lines described above). Optionally, each transfer cable 16 has a male end and a female end. This allows a user to link customer to link two or more transfer cables 16 together for added length or remove the transfer cable 16 altogether and connect the switches 14 in line with each other.

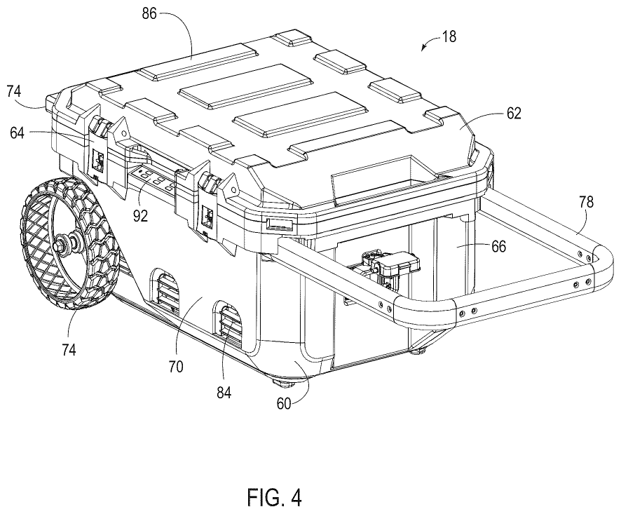

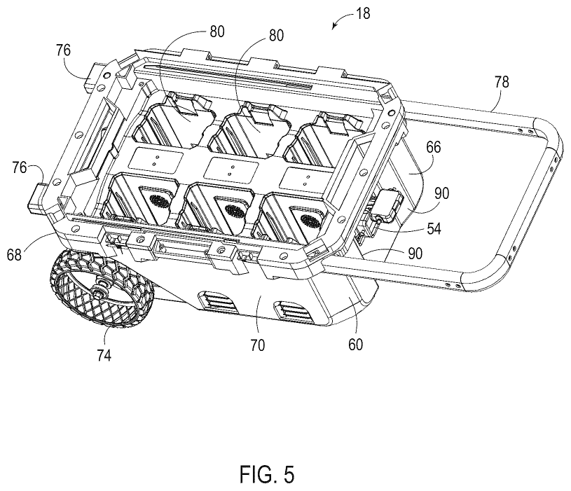

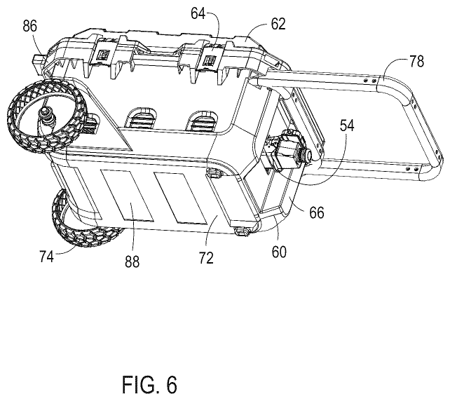

FIGS. 4-6 illustrate one of the battery caddies 18 in more detail. The battery caddie 18 is generally a rectangular solid with a body 60 and a cover 62. The cover 62 is mounted by hinges and can pivot from a closed position to an open position. It may be secured in the closed position using latches 64. The body 60 has a front wall 66, a rear wall 68, side walls 70, and a bottom wall 72. The charging connector 54 is mounted to the front wall 66.

One or more wheels 74 may be mounted to the body 60 to permit rolling transport. In the illustrated example, a single pair of wheels are mounted near the rear wall 68 in such a manner that the battery caddie 18 may be positioned in a horizontal orientation, or may be turned 90 degrees about the rotational axis of the wheels 74 to rest in a vertical orientation. Optional bumpers 76 are provided to stabilize the battery caddie 18 in the vertical orientation.

The battery caddie 18 may include a handle 78 for easy maneuverability. In the illustrated example, the handle 78 is telescoping and may be moved from an extended position (as shown) position to a retracted position against the front wall 66 of the body 60. Optionally, the handle 78 could lock into extended and retracted positions.

The battery caddie 18 includes receptacles 80 providing physical and electrical connections for one or more removable storage batteries 82 (FIG. 2). The receptacles 80 are electrically connected to the charging connector 54, optionally through a power management unit described below. Example removable batteries 82 may be rated at voltages such as 24 V, 40 V, 60 V, or 80 V (nonlimiting examples) and have an amp-hour capacity, size, and weight suitable for use with portable equipment such as lawn and garden equipment. The removable batteries 82 may have different physical configurations such as slide mount or post mount. As used herein, the term “battery” is considered to encompass any device suitable for storing and discharging electrical energy. In the illustrated example, each storage battery 82 includes one or more chemical cells, for example lithium ion cells. Other liquid battery chemistries may be substituted, as well as solid state batteries, capacitors, or similar devices which may exist currently or be later developed. The storage batteries 82 may be bare cells, or they may include ancillary electrical components such as, transformers, voltage converters, relays, circuit breakers, and/or sensors for determining parameters such as state of charge (e.g., temperature sensors, specific gravity sensors).

The receptacles 80 may be configured so that all of the batteries 82 are oriented in the same direction, to provide an intuitive insertion direction.

The battery caddie 18 may be configured for indoor and outdoor use. For example, all components of the battery caddie may be made waterproof using an appropriate combination of gaskets, seals, and design features.

Optionally, an electric fan (not visible in the figure) may be provided internally to the battery caddie 18 to discharge air and pull cold external air though batteries 82. The fan pulls air from the top of one row of batteries 82 and the bottom of the other row of batteries 82. The fan exhaust faces the side or downward depending on caddie orientation.

In conjunction with the fan, the battery caddie 18 may include partially hidden and/or downward facing air inlets 84 for cooling the batteries 82 before and/or during the charging process. The inlets 84 may face the side or downward depending on caddie orientation. Optionally, the air inlets 84 may incorporate hydrophobic mesh to avoid water ingestion.

Optionally, the battery caddie 18 includes integrated tiedown locations 86 that still allow for the cover 62 to be opened. This makes it easy to keep the battery caddie 18 strapped down and still access to the batteries 82.

Optionally, the battery caddie 18 may include a metal plate to reinforce the locking area around the latches 64. A customer can use a standard pad-lock to lock the cover 62 to the body of the battery caddie 18.

In one aspect, the battery caddies 18 are stackable and have protruding lugs 86 in the cover 62 that interlock with complementary recesses 88 in the bottom wall 72.

In one aspect, the charging connector 54 is protected with protruding surfaces 90. This avoids the plug of the charging cable 20 getting caught and avoids damage to the charging connector 54.

In one aspect, the battery caddie 18 has features on the bottom that allow for connecting it to a bracket (e.g., in a trailer) or a piece of mobile equipment such as a zero turn riding lawnmower. This feature makes the battery caddie 18 easy to mount or dismount without having to use tiedowns or undo straps.

The battery caddie 18 may be equipped a display 92 (for example LEDs) indicating the charge status of the battery caddie 18 and/or individual batteries therein. In this example, six status LEDs are shown between the latches 64. They are visible from exterior with the cover 62 open or closed.

Referring back to FIG. 2, the battery caddie 18 includes a power management unit (PMU) 94 which is operable to receive charging current from the associated switch 14 and deliver it to one or more of the storage batteries 82.

A power management unit controller 96 is provided for the power management unit 94. The power management unit controller 96 includes one or more processors capable of executing ladder logic, programmed instructions, or some combination thereof. For example, it may be a general-purpose microcomputer of a known type, such as a PC-based computer, or may be a custom processor, or may incorporate one or more programmable logic controllers (PLC).

The power management unit 94 physically incorporates or is connected to means for selectively controlling the charging power delivered to each battery 82. In the illustrated example, a switching power supply 98 is provided for each of the batteries 82. The power management unit controller 96 is operably connected to the switching power supplies 98 such that it can control their outputs individually. Stated another way, the effect of the power management unit 94 is that it can charge each battery 82 at an independently selectable rate.

The power management unit controller 96 includes and/or is coupled to appropriate sensors for determining the state of the batteries 82, including but not limited to voltage measuring devices, resistance measuring devices, temperature measuring devices, and data communication devices. For example, the power management unit controller 96 may be operable to receive a signal from an individual battery 82 describing that battery's nominal voltage and/or maximum capacity.

The power management unit controller 96 also has a connection for receiving signals and/or data from the switches 14. These connections are shown as data lines 100 in the example. Alternatively, signals and/or data could be exchanged between the power management unit 94 and the associated switch 14 using a wireless connection, such as Bluetooth or Wi-Fi or LoRa.

The power management unit 94 may be programmed with appropriate logic for charging the batteries 82. An example of an operating method is described below.

The power management unit 94 first determines the state of the batteries 82. It determines the nominal voltage, charge capacity, and current charge state of each battery 82, using the sensors described above. It may also use the sensors described above to determine if any of the batteries has a problem which will prevent it from being charged (for example being too hot or too cold).

Table 1 below describes condition of a set of six batteries contained in a battery caddie 18. In this example, the batteries are nominal 82 Volt batteries. They have varying capacities and varying states of charge. In this example, none of the batteries has a problem which would prevent it from accepting a charge.

TABLE 1
initial battery condition

| | | starting | charge | |
|---|---|---|---|---|
| slot # | capacity (A-h) | % charge | % needed | W-h to 100% |
| 1 | 6 | 0 | 100 | 492 |
| 2 | 8 | 2 | 98 | 643 |
| 3 | 6 | 0 | 100 | 492 |
| 4 | 10 | 7 | 93 | 763 |
| 5 | 8 | 5 | 100 | 656 |
| 6 | 8 | 5 | 95 | 623 |
| | | | total W-h | 3669 |

Once the individual battery condition has been determined, the power management unit 94 determines the charging rate for each battery 82. More specifically, it determines a power level to be delivered to that battery 82. The power management unit 94 is preprogrammed with, or is supplied with, information as to the charging power available. In the illustrated example, charging power is supplied at 240 V and approximately 3660 W are available. The charging power computations may be varied as required for different voltages and charger power levels.

Table 2 below lists an example of a computed charging power split based on the battery condition of Table 1 above. In this example, the proportion of the charging power delivered to an individual battery is approximately the same as the proportion of the watt hours needed by that battery to the total watt hours required by all six batteries. Dividing the power split in this proportion will have the result of bringing altered the batteries to fully charge condition at approximately the same time.

TABLE 2
charging power split

| | | power to | | charge time |
|---|---|---|---|---|
| slot # | power split (%) | slot (W) | amps @ 82 V | (minutes) |
| 1 | 13.4 | 450.6 | 5.5 | 65.5 |
| 2 | 17.5 | 588.8 | 7.2 | 65.5 |
| 3 | 13.4 | 450.6 | 5.5 | 65.5 |
| 4 | 20.8 | 698.4 | 8.5 | 65.5 |
| 5 | 17.9 | 600.8 | 7.3 | 65.5 |
| 6 | 17.0 | 570.8 | 7.0 | 65.5 |

Once the power split has been determined as described above, the power management unit 94 delivers the power to each of the batteries 82. In some configurations, the battery caddie 18 may have continuous access to charging power. In other situations, a single charger made provide power to multiple caddies. In such instances, the power management unit 94 signals to the connected device (i.e. charger or switch) that it requires charging power. Once the battery charging cycle is complete, the power management unit 94 terminates the signal indicating it requires charging power and/or sends a signal indicating charging is complete.

Optionally, the power management unit 94 may be configured or programmed to ignore one or more batteries 82. For example, the battery caddie 18 might have six batteries 82 inserted with one of the batteries 82 having an error, for example being two hot or too cold. The power management unit 94 would compute the charging power split as described above on the basis of five batteries, and charge the five other batteries 82. Once the charge cycle is complete, the power management unit 94 may recheck the status of the batteries 82. In some instances, a battery error may resolve itself with time, in which case it would be eligible for charging on a subsequent cycle.

Two or more of the battery caddies 18 may be operated in conjunction with the charger 12 and switches 14 described above to operate as a battery charging system.

Referring to FIG. 2, an example is shown in which there is one charger 12, three switches 14, labeled A, B, and C, respectively, for identification purposes. Each switch 14 is a battery caddie 18 connected thereto. These are labeled a, b, and c, respectively, for identification purposes.

In this method, each of the switches 14 is configured and/or programmed to receive the signal from the associated battery caddie 18 indicating that charging power is required, and in response thereto direct charging current from its input connection 38 to its output connection 40 (referred to as the charging condition of the switch 14). Each of the switches 14 is further configured to direct charging current from its input connection 38 to its pass-through connection 42, either in the absence of the signal requiring charging current from its associated battery caddie 18, or in response to a signal that charging is complete from its associated battery caddie 18.

Furthermore, in this exemplary method, the charger 12 is configured and/or programmed to receive a signal from the switch 14 indicating that it is in the charging condition. If none of the switches 14 transmit such a signal, the charger 12 does not deliver any charging current to the switches 14. If any of the switches 14 transmit such a signal, the charger 12 delivers charging current to the string of switches 14.

This configuration of the system 10 results in a sequential charging process.

For example, battery caddies a, b, and c may be coupled to switches A, B, and C, respectively. It is assumed for purposes of this example that each caddie a, b, and c contains batteries which require charging and do not have any problems which would prevent them from accepting a charge. Accordingly, each of the battery caddies 18 signals to its connected switch A, B, and C that it requires charging current. This will cause each of the switches A, B, and C to move to its charging condition as described above. Because switch A is most upstream or stated another way closest to the charger 12, it will direct charging current to its caddie a. That caddie a will charge its batteries 82 using the logic described above until the cycle is complete at which time it will signal the end of charge to the connected switch A.

Switch A will then change from its charging condition to its pass-through condition and permit charging current to pass to switch B. The charging cycle described above will be repeated for caddie b which is coupled to switch B.

Switch B will then change from its charging condition to its pass-through condition and permit charging current to pass to switch C. The charging cycle described above will be repeated for caddie c which is coupled to switch C.

Once the charging cycle of switch C is complete, it will change from charging condition to its pass-through condition. At this time, caddies a, b, and c will all contain fully charged batteries. None of the switches A, B, or C will indicate a requirement for charging power. Accordingly, charger 12 will stop delivering charging power.

As described above, it is possible that one or more batteries 82 in one of the caddies 18 may have a fault preventing them from being charged the first charge cycle. Some of these faults may resolve with time. In this case, the associated power management unit 94 would recheck the battery condition and signal to its associated switch 14 that it requires charging power. As this will in turn cause the charger 12 to continue delivering charging power so that the previously faulty batteries related to can be charged in a second cycle through the switches 14.

Should a user couple or uncouple battery caddies 18 during charging, the sequence will simply carry on using the logic described above. For example, if an initial charge is begun with only caddies b and c connected, caddie b will receive charging current first. If, while caddie b is charging, a caddie is coupled to switch A, then switch A will change to the charging condition and will direct power to its caddie a, terminating the charge on caddie b until such time as caddie a is finished.

Stated another way, the battery caddies 18 sequentially charge with the switches 14 diverting power so that input power can be fully utilized without requiring timers.

The system is effectively charging as many batteries as possible in the beginning, then it comes back to charge the batteries that may have had issues at the end.

Numerous physical configurations of the charging system 10 are possible. As illustrated in FIG. 1, the charger 12 and the switches 14 are mounted in a fixed position in a building. The battery caddies 18 would be moved into position near the switches 14 and connected with charging cables 16. When charging is complete, caddies 18 may be removed and taken to a different location for use, or placed in a vehicle for transport.

In another example configuration, the switches 14 could be mounted one each, along with a battery caddie 18, in a plurality of vehicles such as trucks, trailers, or riding mowers. The plurality of vehicles would then be moved into proximity of the charger 12, and the switches 14 coupled to the charger 12 using transfer cables 16 as described above.

While the charging system 10 has been described as having power management units 94 in each of the caddies 18, it will be understood that the functionality of the power management units 94, that is the function of determining the state of multiple batteries within a caddie, determining the appropriate charge power split, and delivering the appropriate charging power per battery, could be incorporated into other portions of the charging system 10.

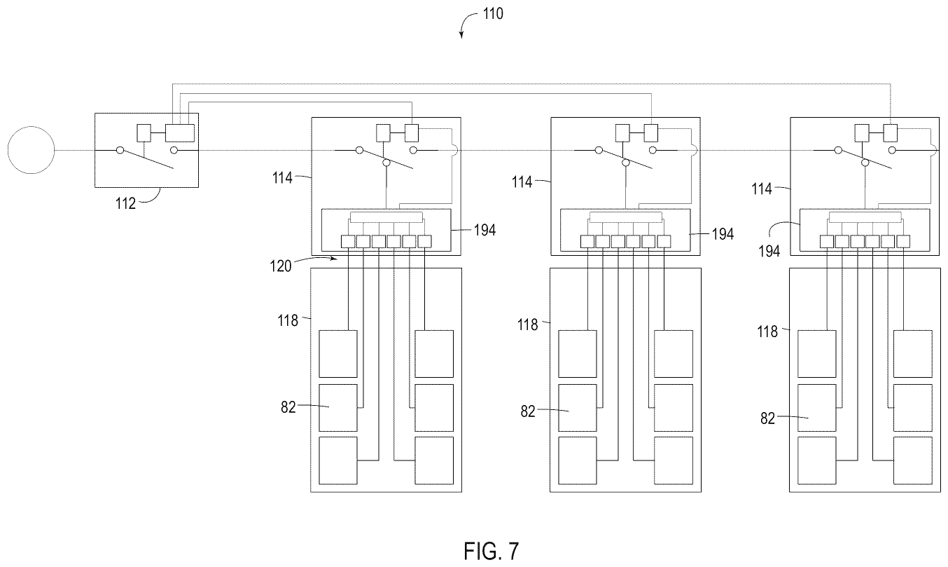

One alternative configuration of a charging system 110 is shown schematically in FIG. 7. It includes a charger 112, switches 114, and caddies 118. Unlike the charging system 10 described above, the caddies 118 do not include power management units. instead, each switch 114 includes a power management unit 194. Operation of the charging system 110 is substantially the same as described above for charging system 10, with the exception that the functions of the power management unit or performed within the switches 114. As compared to the charging system 10 described above, the caddies 118 are lighter, simpler, and have fewer components than the caddies 18. The charging cables 120 would have more conductors contained therein than the charging cables 20 described above.

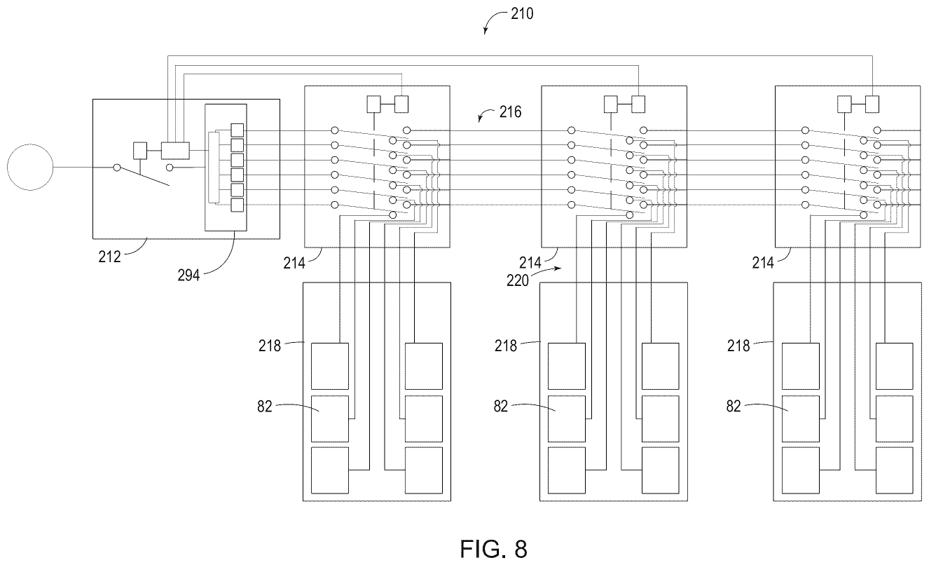

Another alternative configuration of a charging system 210 is shown schematically in FIG. 8. It includes a charger 212, switches 214, and caddies 218. Unlike the charging system 10 described above, the caddies 218 do not include power management units. Instead, the charger 212 includes a single power management unit 294. Operation of the charging system 210 is substantially similar as described above for charging system 10, with the exception that the functions of the power management unit are performed within the charger 212. As compared to the charging system 10 described above, the caddies 218 are lighter, simpler, and have fewer components than the caddies 18. The charging cables 220 and the transfer cables 216 would have more conductors contained therein than the corresponding charging cables 20 and transfer cables 16 described above.

The method and apparatus described above has certain benefits and advantages. It effectively charges as many batteries as possible in a given timeframe.

The foregoing has described a battery caddy. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A battery caddie, comprising:
a body having one or more receptacles for receiving one or more batteries;
a cover movable between an open position which exposes the one or more receptacles, and a closed position;
a charging connector; and
an electrical connection between the charging connector and the one or more receptacles.

2. The battery caddie of claim 1, further comprising:
a power management unit is coupled to one or more sensors for determining the state of one or more batteries when disposed in respective ones of the one or more receptacles.

3. The battery caddie of claim 2, wherein the power management is coupled to means for selectively controlling charging power delivered to each of the one or more receptacles.

4. The battery caddie of claim 2, wherein the power management is configured to generate a signal that it requires charging power.

5. The battery caddie of claim 1, further comprising a status display configured to indicate a charge status of one or more batteries when disposed in respective ones of the one or more receptacles.

6. The battery caddie of claim 1, further comprising one or more wheels mounted to the body.

7. The battery caddie of claim 6, wherein the one or more wheels are mounted such that the caddie can pivot between a horizontal position and a vertical position.

8. The battery caddie of claim 1, further comprising a handle mounted to the body and movable between an extended position and a retracted position.

9. The battery caddie of claim 1, further comprising a fan communicating with the one or more receptacles and with one or more air inlets formed in the body.

10. The battery caddie of claim 9, wherein the air inlets are mounted adjacent a bottom wall of the body.

11. The battery caddie of claim 1, further including at least one tiedown location integrated into the body that allow the cover tom move between the open and closed positions.

12. The battery caddie of claim 1, wherein the charging connector is protected by protruding surfaces of the body.

13. The battery caddie of claim 1, further comprising;
protruding lugs in one of the cover and the body; and
complementary recesses in the other of the cover and the body that interlock with the lugs.

14. The battery caddie of claim 1, wherein the battery caddie is configured to receive two or more batteries and includes a power management unit configured to provide independent charging power to each of the two or more batteries.

15. The battery caddie of claim 14, wherein the power management unit is configured to determine a state of the two or more batteries and to generate a signal indicating that it requires charging power.
